(19) United States
(12) Patent Application Publication
(10) Pub. No.: US 2007/0296272 A1
(43) Pub. Date: Dec. 27, 2007

(54) DRIVING DEVICE WITH COMMON DRIVER

(75) Inventors: Chih-Jen Yen, Hsinchu City (TW); Chih-Yuan Hsieh, Chiayi City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: NOVATEK MICROELECTRONICS CORP., Hsinchu (TW)

(21) Appl. No.: 11/611,144

(22) Filed: Dec. 15, 2006

(30) Foreign Application Priority Data
Jun. 23, 2006 (TW) 95122705

(51) Int. Cl. H02J 3/00

(52) U.S. Cl. 307/11

(57) ABSTRACT

A driving device with a common driver for driving a plurality of loadings is provided. The driving device includes a first driver and a plurality of first switches. The first driver enhances the driving ability of input data received and outputs the input data. The first terminal of the first switches is electrically connected to the output terminal of the first driver and the second terminal of the first switches is electrically connected to the corresponding loading of the loadings.

### CROSS-REFERENCE TO RELATED APPLICATION

This application claims the priority benefit of Taiwan application serial no. 95122705, filed Jun. 23, 2006. All disclosure of the Taiwan application is incorporated herein by reference.

### BACKGROUND OF THE INVENTION

1. Field of the Invention

The present invention relates to a driving device, and more particularly to a driving device with a common driver capable of reducing output voltage error and power consumption, and also the fabrication cost.

2. Description of Related Art

FIG. 1 is a circuit diagram of a conventional driving device. When the driving device is driving a variety of loadings, a different driver drives each loading. As shown in FIG. 1, the data output unit 110 outputs driving data to the drivers 11, 12, 13, 14, . . . , 1n. The drivers 11, 12, 13, 14, . . . , 1n drive the corresponding loadings L11, L12, L13, L14, . . . , L1n. Meanwhile, buffers 101˜10n are also installed inside the respective drivers 11˜1n for buffering data signals.

The foregoing method of driving the loadings with different drivers has some defects. First, the number of drivers has to increase as the number of loadings is increased. Therefore, the driving device may have to occupy a larger area when it needs to drive a large number of loadings. Furthermore, as the number of devices increases, the loading of the previous stage is increased. As a result, the power consumption is increased. In the meantime, because different drivers are located at a different distance from one another, they have different voltage or current offsets. As shown in FIG. 1, the first driver 11 has a voltage (or current) offset VOS11, the second driver 12 has a voltage offset VOS12 and the other drivers have voltage offsets VOS13, VOS14 . . . VOS1n respectively. Hence, in a driving device with a large number of output drivers, level errors resulting from the offset may lead to a significant drop in the precision. For example, the data lines on a liquid crystal display panel need to be driven. Because the data lines on the liquid crystal display panel is responsible for controlling the corresponding pixel units, a large number of data lines is required to produce the desired resolution in the liquid crystal display panel. Therefore, a large number of data output drivers are needed to drive the liquid crystal display panel. However, as the number of drivers increases, a larger area is needed to accommodate the drivers so that the cost of producing the liquid crystal display panel is increased. Moreover, as the number of driver increases, their average distance of separation from one another is even greater. Hence, the input offset errors between the drivers are enlarged leading to a poor display quality. Meanwhile, increasing the number of driver also burdens the previous stage with a larger loading so that the power consumption is increased.

### SUMMARY OF THE INVENTION

Accordingly, at least one objective of the present invention is to provide a driving device with a common driver capable of reducing the devices and lowering overall power consumption. In the meantime, the driving device is able to reduce offset errors of output so that a more precise resolution of the output voltage or current is provided.

To achieve these and other advantages and in accordance with the purpose of the invention, as embodied and broadly described herein, the invention provides a driving device with common driver for driving a plurality of loadings. The driving device includes a first driver and a plurality of first switches. The first driver enhances the driving ability of input data received and outputs the input data. The first terminal of the first switches is electrically connected to the output terminal of the first driver and the second terminal of the first switches is electrically connected to the corresponding loading of the loadings.

According to one preferred embodiment of the present invention, the foregoing driving device further includes a first buffer electrically connected to the second terminal of the corresponding switch in the plurality of first switches and the plurality of loadings. Furthermore, the output terminal of the first buffer is electrically connected to the first terminal of the plurality of first switches. In addition, the first buffer may further include a first data converter. The first data converter is electrically connected to the first buffer for converting digital input data into analog input data or sampling analog data to extract sampled data and outputting the data to the first buffer.

According to one preferred embodiment of the present invention, the foregoing driving device further includes a second driver and a plurality of second switches. The second driver enhances the driving ability of input data received and outputs the input data. The first terminal of the plurality of second switches is electrically connected to the output terminal of the second driver and the second terminal of the plurality of second switches is electrically connected to the corresponding loading of the loadings. Moreover, the first terminal of a plurality of second parasitic capacitors are electrically connected to the second terminals of the corresponding switch in the plurality of second switches, and the second terminal of the plurality of second parasitic capacitors are electrically connected to a reference voltage.

According to one embodiment of the present invention, the loadings having electrical connection to the plurality of first switches and the loadings having electrical connection to the plurality of second switches are alternately disposed or block disposed. In addition, the driving device further includes a plurality of second parasitic resistors and second buffers. The plurality of second parasitic resistors is electrically connected between the second terminal of the corresponding switches in the plurality of second switches and the first terminal of the corresponding parasitic capacitors in the plurality of second parasitic capacitors. The output terminal of the second buffer is electrically connected to the first terminal of the plurality of second switches. Moreover, the second driver further includes a second data converter. The second data converter is electrically connected to the second buffer for converting digital input data into analog input data or sampling analog data to extract sampled data and outputting the data to the second buffer.

According to one embodiment of the present invention, the plurality of loadings in the driving device is the pixel units in a display panel. Furthermore, the display panel is a liquid crystal display panel.

The present invention deploys a driving device with a common driver so that a plurality of loadings can use a common driver and reduce the number of drivers in the driving device. Hence, the driving devices can occupy a smaller area and consume less power. Meanwhile, decreasing the number of drivers can reduce their average distance of separation from one another and increase their symmetry. With enhanced symmetry, output voltage or current error is minimized. Therefore, the present invention can provide a precise output voltage or current output resolution.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a circuit diagram of a conventional driving device.

FIG. 2A is a circuit diagram of a driving device with common driver according to one embodiment of the present invention.

FIG. 2B is a circuit diagram of an alternative first driver 201 according to another embodiment of the present invention.

FIG. 2C is a circuit diagram of a driving device with common driver according to another embodiment of the present invention.

FIG. 3A is a circuit diagram of a driving device with common driver according to another embodiment of the present invention.

FIG. 3B is a circuit diagram of an alternative first driver 301 according to another embodiment of the present invention.

FIG. 3C is a circuit diagram of an alternative second driver 302 according to another embodiment of the present invention.

FIG. 3D is a circuit diagram of a liquid crystal display driving device according to another embodiment of the present invention.

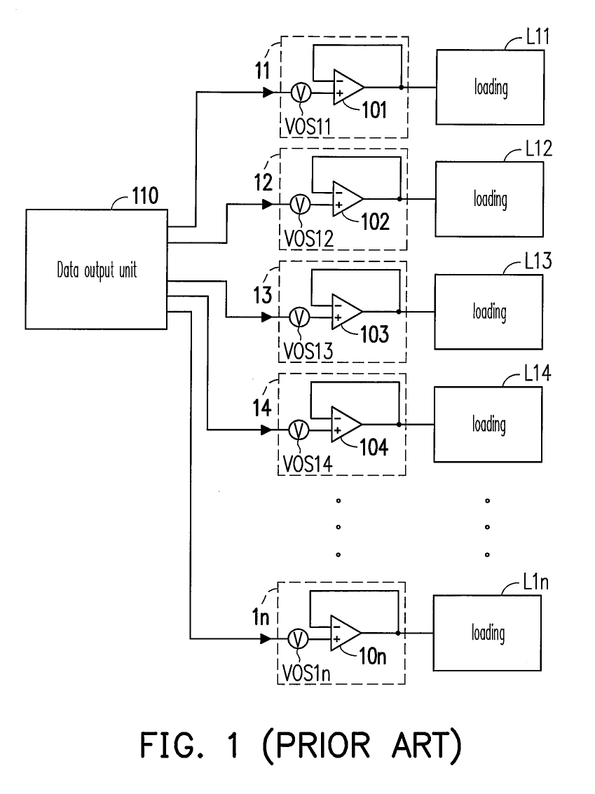

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

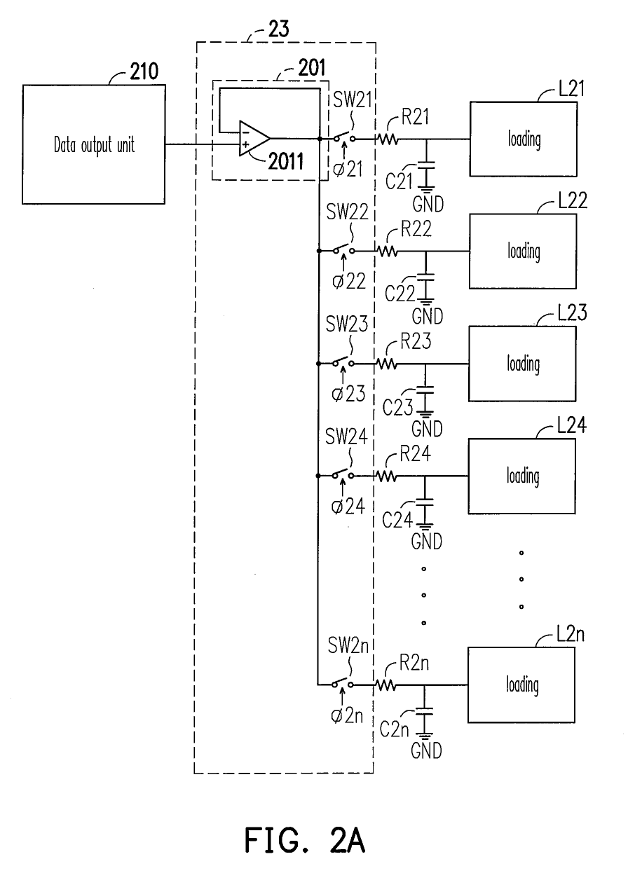

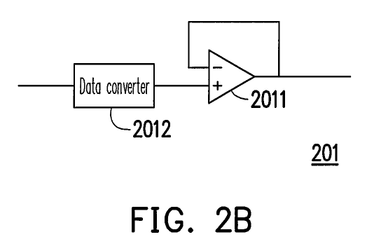

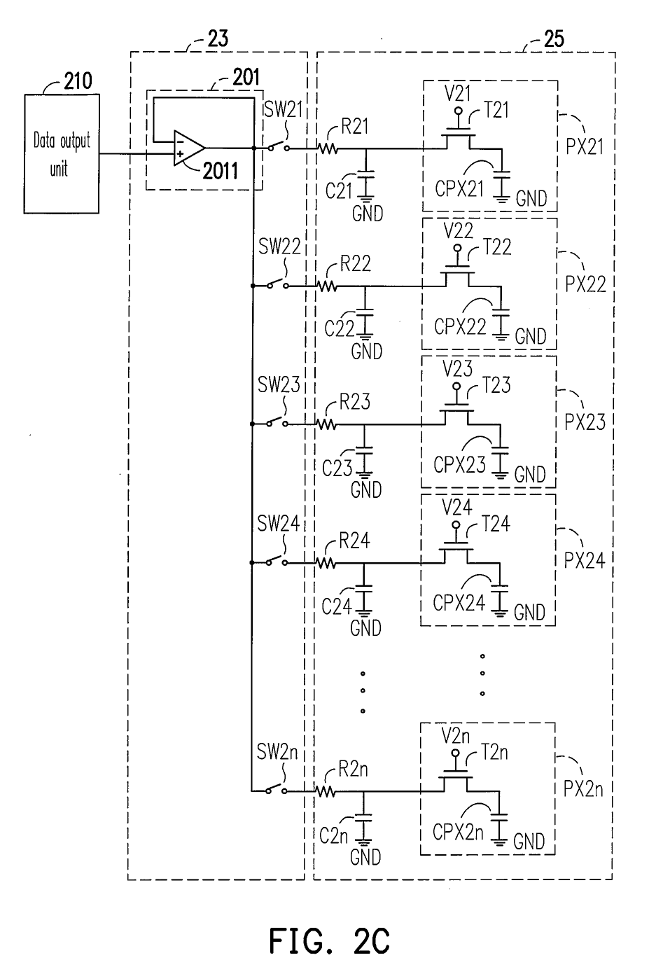

FIG. 2A is a circuit diagram of a driving device with common driver according to one embodiment of the present invention. In the present embodiment, the data output unit 210 outputs data to the common driver driving device 23 for driving the loadings L21˜L2n. The common driver driving device 23 includes a first driver 201, a plurality of first switches SW21˜SW2n, a plurality of first parasitic resistors R21˜R2n and a plurality of first parasitic capacitors C21˜C2n. The first driver 201 enhances the driving capability of the input data received and outputs the input data to the first switches SW21˜SW2n. The first terminal of the first switches SW21˜SW2n are electrically connected to the output terminal of the first driver 201 and the second terminal of each of the first switches SW21˜SW2n is electrically connected to the corresponding loading. The second terminal of each of the first parasitic capacitors C21˜C2n is electrically connected to a reference voltage. Here, the reference voltage is a ground voltage GND. The first resistors R21˜R2n are electrically connected to the second terminal of the first switches SW21˜SW2n and the corresponding first terminal of the first parasitic capacitors C21˜C2n.

In addition, the first driver 201 includes a first buffer 2011. The output terminal of the first buffer 2011 is electrically connected to the first terminal of the first switches SW21˜SW2n for providing a buffering function. The data output unit 210 provides output data to the input terminal of the first driver 201 and the first driver 201 enhances the driving ability of the input data received and outputs the input data. The first switches SW21, SW22, . . . , SW2n together form a first switching group connected to the output terminal of the first driver 201. The first switching group controls the first switches SW21, SW22, . . . , SW2n according to the first control signals φ21˜φ2n to drive the corresponding loadings. The input data received by the first driver 201 can be data in a variety of forms (for example, digital data, analog data or sampled data). FIG. 2B is a circuit diagram of an alternative first driver 201 according to another embodiment of the present invention. As shown in FIG. 2B, the first driver 201 includes a first buffer 2011 and a data converter 2012. The data converter 2012 is electrically connected to the first buffer 2011 and capable of converting digital data into analog data or sampling analog data to extract sampled data and outputting to the first buffer 2011.

The first driver 201 is the only common driver in the driving device 23. Each of the switches SW21˜SW2n switches on or off according to the timing sequence of the first control signals φ21˜φ2n so that the driving device 23 can individually drive the loadings L21˜L2n. For example, the first control signals φ21˜φ2n short the switch SW21 so that the first driver 201 drives the loading L21. Then, the first control signals φ21˜φ2n open the switch SW21 and short the switch SW22 so that the first driver 201 drives the loading L22. The first control signals φ21˜φ2n take turn to short the switches SW21˜SW2n and their operations are similar. The driving mode of the common driver in the present embodiment is able to reduce the number of drivers. Moreover, the errors in the voltage or current level to various loadings when the same driver is used are considerably less than the errors when driven by different drivers.

FIG. 2C is a circuit diagram of a driving device with common driver according to another embodiment of the present invention. In the present embodiment, the plurality of loadings to be driven is that of the pixel units PX21˜PX2n of a liquid crystal display panel 25. The pixel units PX21˜PX2n include thin film transistors (TFT) T21˜T2n and pixel capacitors CPX21˜CPX2n. Here, the control voltages V21˜V2n control the thin film transistors T21˜T2n to determine whether or not the pixel capacitors CPX21˜CPX2n accept the data control. The data output unit 210 provide output data to the first driver 201 of the driving device 23 and the first driver 201 outputs voltage to the various pixel capacitors CPX21˜CPX2n of the liquid crystal display panel 25 through the switches SW21˜SW2n using time division multiplexing. Hence, the driving capability of the driving device is effectively used.

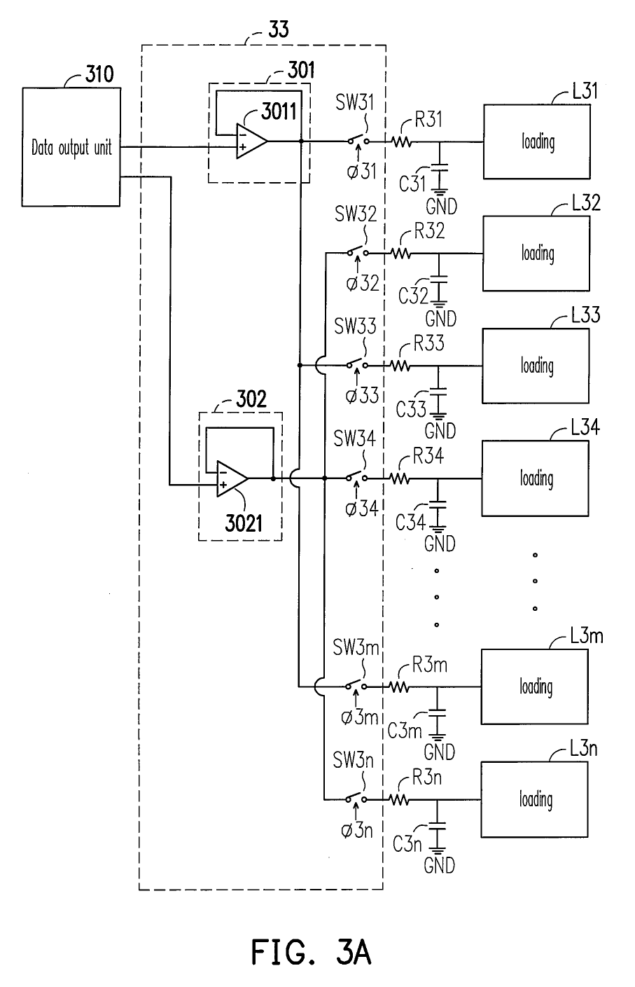

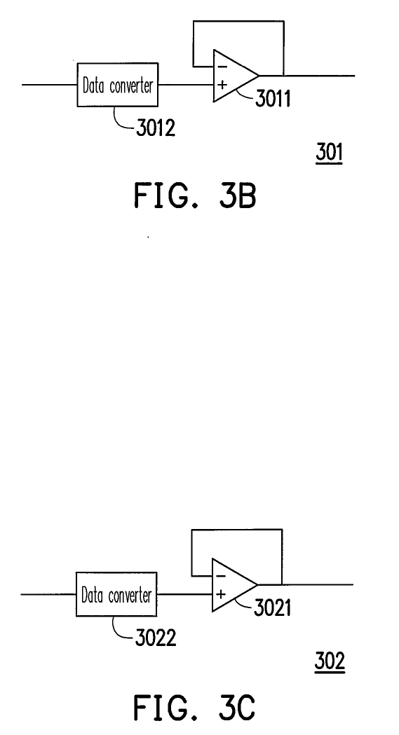

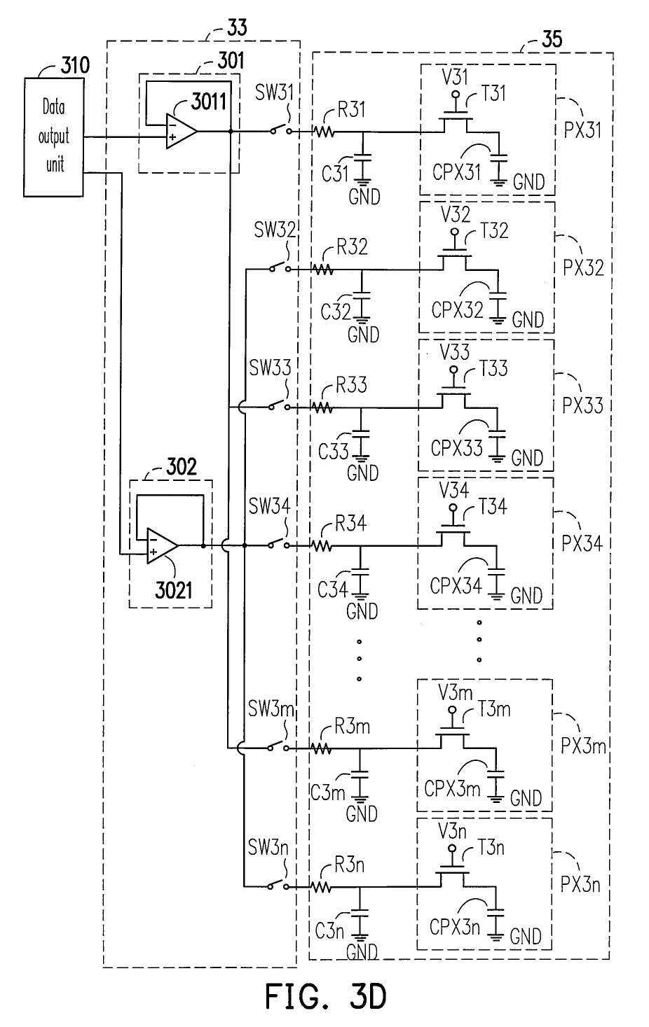

FIG. 3A is a circuit diagram of a driving device with common driver according to another embodiment of the present invention. The present embodiment is different from the foregoing embodiment in that the data output unit 310 outputs data to the driving device 33 having two drivers 301 and 302 such that the driver 301 drives the loadings L31, L33, . . . , L3m while the driver 302 drives the loadings L32, L34, . . . , L3n.

In the present embodiment, a two-part analysis of the driving device can be made. The data output unit 310 provides output data to the input terminal of the first driver 301 and the second driver 302. The first switches SW31, SW33, . . . , SW3m together form a first switching group connected to the output terminal of the first driver 301. According to the first control signals φ31, φ33, . . . , φ3m, the first switching group controls the first switches SW31, SW33, . . . , SW3m to drive the corresponding loadings. The second switches SW32, SW34, . . . , SW3n together form a second switching group connected to the output terminal of the second driver 302. According to the second control signals φ32, φ34, . . . , φ3n, the second switching group controls the second switches SW33, SW34, . . . , SW3n to drive the corresponding loadings. First, through the switching of the first switches SW31, SW33, . . . , SW3m and according to the timing sequence of the first control signals φ31, φ33, . . . , φ3m, the first driver 301 outputs voltage via the first parasitic resistors R31, R33, . . . , R3m and the first parasitic capacitors C31, C33, . . . , C3m to drive the loadings L31, L33, . . . , L3m. Similarly, through the switching of the second switches SW32, SW34, . . . , SW3n and according to the timing sequence of the second control signals φ32, φ34, . . . , φ3n, the second driver 302 outputs voltage via the second parasitic resistors R32, R34, . . . , R3n and the second parasitic capacitors C32, C34, . . . , C3n to drive the loadings L32, L34, . . . , L3n. For example, the first control signals φ31, φ33, . . . , φ3m short the switch SW31 and the second control signals φ32, φ34, . . . , φ3n short the switch SW32 so that the first driver 301 drives the loading L31 and the second driver 302 drives the loading L32 simultaneously. Then, the first control signals φ3 φ33, . . . , φ3m open the switch SW31 and the second control signals φ32, φ34, . . . , φ3n open the switch SW32 simultaneously. Thereafter, the first control signals φ3 φ33, . . . , φ3m and the second control signals φ32, φ34, . . . , φ3n sequentially short the switches SW31˜SW3m and the switches SW32˜SW3n simultaneously in a similar way so that the first driver 301 and the second driver 302 drive a different loading simultaneously.

In the present embodiment, the loadings L31, L33, . . . , L3m connected to the first switches SW31, SW33, . . . , SW3m and the loadings L32, L34, . . . , L3n connected to the second switches SW32, SW34, . . . , SW3n are alternately disposed. Therefore, the first driver 301 and the second driver 301 are able to drive an alternate set of the loadings L31, L32, L33, L34, . . . , L3m, L3n. However, anyone familiar with the technology may arrange to drive the loadings L31, L32, L33, L34, . . . , L3m, L3n in whatever order and sequence one desired. Alternatively, more than two drivers may be simultaneously used to drive more loadings.

The first driver 301 and the second driver 302 have a first buffer 3011 and a second buffer 3021 for buffering the received input data. The data output unit 310 provides input data of whatever form (for example, digital data, analog data or sampled data). FIG. 3B is a circuit diagram of an alternative first driver 301 according to another embodiment of the present invention. The first driver 301 includes a first buffer 3011 and a data converter 3012. The data converter 3012 can convert digital input data into analog data or sample analog data to extract sampled data and output the data to the first buffer 3011 via an electrical connection. FIG. 3C is a circuit diagram of an alternative second driver 302 according to another embodiment of the present invention. The second driver 302 includes a second buffer 3021 and a data converter 3022. The data converter 3022 can convert digital input data into analog data or sample analog data to extract sampled data and output the data to the second buffer 3021 via an electrical connection.

In the present embodiment, the driving device 33 uses two drivers 301 and 302 to achieve the functions of saving area, reducing voltage error and lowering the loading of previous stage promised by using common drivers. However, anyone familiar with the technology may understand that the number of common drivers in the driving device is not limited to one or two. The same driving device may use a plurality of drivers such that each driver in turn drives a plurality of corresponding loadings.

FIG. 3D is a circuit diagram of a liquid crystal display driving device according to another embodiment of the present invention. In the present embodiment, the driving device 33 is used to drive a plurality of loadings and the loadings are the pixel units PX31˜PX3n of a liquid crystal display panel 35. However, the loadings being driven by the drivers are not limited to the liquid crystal display panel. The pixel units PX31˜PX3n include a plurality of thin film transistors T31˜T3n and a plurality of pixel capacitors CPX31˜CPX3n. Gate voltages V31˜V3n are output to the gates of the thin film transistors T31˜T3n to control the time for the pixel capacitors CPX31˜CPX3n receiving data input. The data output unit 310 provides output data to the first driver 301 and the second driver 302. Then, the first driver 301 outputs voltage to the various pixel capacitors CPX31, CPX33, . . . , CPX3m of the liquid crystal display panel 35 through the switches SW31, SW33, . . . , SW3m using time division multiplexing. Similarly, the second driver 302 outputs voltage to the various pixel capacitors CPX32, CPX34, . . . , CPX3n of the liquid crystal display panel 35 through the switches SW32, SW34, . . . , SW3n using time division multiplexing. The first driver 301 and the second driver 302 control a different set of the pixel units PX31˜PX3n so that the driving capability of the driving device is effectively used.

In summary, the driving device in the present invention uses a common driver structure and switches to control the input and output of data. Through the use of common drivers, the number of devices and circuit area is significantly reduced. In the meantime, output voltage or current errors due to power consumption and route of transmission are also substantially reduced. Thus, not only is the loading carried by the previous stage reduced, the output resolution is also increased. In other words, the present invention can effectively reduce the cost, power consumption and output errors of the driving device.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A driving device with a common driver for driving a plurality of loadings, comprising:
a first driver for enhancing a driving capability of received input data and outputting the received input data; and
a plurality of first switches having a first terminal electrically connected to an output terminal of the first driver and a second terminal of the first switches electrically connected to the corresponding loadings of the loadings.

2. The driving device of claim 1, wherein the first driver comprises a first buffer including an output terminal electrically connected to the first terminal of the first switches.

3. The driving device of claim 2, wherein the first driver further comprises a first data converter electrically connected to the first buffer for converting digital input data into analog input data or sampling analog data to extract sampled data and outputting the analog input data or the sampled data to the first buffer.

4. The driving device of claim 1, further comprising:
a second driver for enhancing the driving capability of received input data and outputting the received input data; and
a plurality of second switches having their first terminals electrically connected to an output terminal of the second driver and their second terminals electrically connected to corresponding loadings of the loadings.

5. The driving device of claim 4, wherein the loadings with electrical connection to the first switches and the loading with electrical connection to the second switches are alternately disposed or block disposed.

6. The driving device of claim 4, wherein the second driver comprises a second buffer including an output terminal electrically connected to the first terminal of the second switches.

7. The driving device of claim 6, wherein the second driver further comprises a second data converter electrically connected to the second buffer for converting digital input data into analog input data or sampling analog data to extract sampled data and outputting the analog input data or the sampled data to the second buffer.

8. The driving device of claim 1, wherein the loadings comprise pixel units of a display panel.

9. The driving device of claim 8, wherein the display panel is a liquid crystal display panel.

10. A driving device for driving a liquid crystal display panel, comprising:
a first driver having an input terminal for receiving display data, for enhancing a driving capability of the display data and outputting the received display data from an output terminal of the first driver; and
a first switching group comprising a plurality of first switches such that a plurality of first terminals of the first switches are electrically connected to the output terminal of the first driver and a plurality of second terminals of the first switches are electrically connected to corresponding loadings, wherein the first switching group controls each of the first switches through a first control signal to drive the corresponding loadings.

11. The driving device of claim 10, wherein the first driver comprises a first buffer including an output terminal electrically connected to the first terminal of the first switches.

12. The driving device of claim 11, wherein the first driver further comprises a first data converter electrically connected to the first buffer for converting the digital input data into analog input data or sampling analog data to extract sampled data and outputting the analog input data or the sampled data to the first buffer.

13. The driving device of claim 10, further comprising:
a second driver for enhancing a driving capability of input data received and outputting the received input data; and
a second switching group comprising a plurality of second switches such that a plurality of first terminals of the second switches are electrically connected to the output terminal of the second driver and a plurality of second terminals of the second switches are electrically connected to the corresponding loadings of loadings, wherein the second switching group controls each of the second switches through a second control signal to drive corresponding loading of loadings.

14. The driving device of claim 13, wherein the loadings with electrical connection to the first switches and the loading with electrical connection to the second switches are alternately disposed or block disposed.

15. The driving device of claim 13, wherein the second driver comprises a second buffer including an output terminal electrically connected to the first terminal of the second switches.

16. The driving device of claim 15, wherein the second driver further comprises a second data converter electrically connected to the second buffer for converting the digital input data into analog input data or sampling analog data to extract sampled data and outputting the analog input data or the sampled data to the second buffer.

17. The driving device of claim 10, wherein the loadings comprise pixel units of a display panel.

18. The driving device of claim 17, wherein the display panel is a liquid crystal display panel.
